(19) United States
(12) Patent Application Publication
(10) Pub. No.: US 2011/0038001 A1
(43) Pub. Date: Feb. 17, 2011

(54) PRINTING CONTROL METHOD, A COMPUTER READABLE STORAGE MEDIUM STORING INSTRUCTIONS OF A COMPUTER PROGRAM THEREOF, AND AN IMAGE FORMATION DEVICE

(75) Inventor: Kazuhiro Kamimura, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/850,830

(22) Filed: Aug. 5, 2010

Related U.S. Application Data
(60) Provisional application No. 61/232,946, filed on Aug. 11, 2009.

(30) Foreign Application Priority Data
Jun. 17, 2010 (JP) 2010-138034

(51) Int. Cl. G06F 3/12

(52) U.S. Cl. 358/1.15

(57) ABSTRACT

A printing control method for a processing device transmitting a first and second document data to an image formation device, the first and second document data including first and second print parameters respectively, each of the first and second print parameters being set by a setup window of a printer driver, includes obtaining the first print parameters of the first document data if printing the first document is instructed, storing the first print parameters in a memory, obtaining the second print parameters of the second document data if printing the second document is instructed after printing the first document is instructed, determining whether or not the second print parameters are equal to the first print parameters, and displaying an information that the second print parameters are equal to the first print parameters on a displaying unit, if the second print parameters are equal to the first print parameters.

### CROSS-REFERENCE TO RELATED APPLICATION

This application is based upon and claims the benefit of priority from: U.S. provisional application No. 61/232946, filed on Aug. 11, 2009, the entire contents of which are incorporated herein by reference.

This application is also based upon and claims the benefit of priority from the Japanese Patent Application No. 2010-138034, filed on Jun. 17, 2010, the entire contents of which are incorporated herein by reference.

### FIELD

Embodiments described herein relate generally to a printing control method, a computer readable storage medium storing instructions of a computer program thereof, and an image formation device.

### BACKGROUND

When a user tries to print by using a copy function or a print function, the user sets parameters for print (hereinafter, referred to as “print parameters”) with using a control panel of an image formation device or a PC (Personal Computer) connected to a network. The print parameters may include color/monochrome, number of print copies, zoom, printing multiple pages into a single sheet of paper (N-up printing, N in 1), and duplex printing. The image formation device forms an image on the sheet based on the print parameters.

However, if the image formation device executes to print without having a confirmation of the print parameters by the user, an undesired image could be printed. For example, if the print parameters which are used for a previous print job remain in the image formation device and the user instructs to execute a new print job without setting new print parameters for the new print job, the new print job is carried out based on the print parameters which are used for the previous print.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram of a printer controlling system according to the first embodiment;

FIG. 2 is a block diagram showing software architecture of the printer controlling system;

FIG. 3 is a block diagram explaining a confirmation function of the print parameters;

FIG. 4 is a flow chart explaining operation of the confirmation function of the print parameters;

FIG. 5 is a flow chart explaining operation of the confirmation function of the print parameters;

FIG. 6A shows an example of a confirmation window of the print parameters;

FIG. 6B shows another example of the confirmation window of the print parameters;

FIG. 7 is a block diagram explaining a confirmation function of the print parameters according to the second embodiment;

FIG. 8 is a flow chart explaining operation of the confirmation function of the print parameter;

FIG. 9 is a flow chart explaining operation of the confirmation function of the print parameter;

FIG. 10A shows an example of the confirmation window of the print parameters;

FIG. 10B shows another example of the confirmation window of the print parameters; and

FIG. 11 shows an example of a setup window of the print parameters.

### DETAILED DESCRIPTION

The embodiments will be explained with reference to the accompanying drawings.

According to one aspect of the invention, a printing control method for a processing device transmitting a first and second document data associated with application program to an image formation device, the first and second document data including first and second print parameters respectively, each of the first and second print parameters being set by a setup window of a printer driver, includes obtaining the first print parameters of the first document data if printing the first document is instructed, storing the first print parameters in a memory, obtaining the second print parameters of the second document data if printing the second document is instructed after printing the first document is instructed, determining whether or not the second print parameters are equal to the first print parameters, and displaying an information that the second print parameters are equal to the first print parameters on a displaying unit, if the second print parameters are equal to the first print parameters.

According to another aspect of the invention, a computer readable storage medium storing instructions of a computer program for transmitting a first and second document data associated with application program to an image formation device, the first and second document data including first and second print parameters respectively, each of the first and second print parameters being set by a setup window of a printer driver, the computer program which when executed by a computer results in performance of steps includes a program module for instructing a computer to obtain the first print parameters of the first document data if printing the first document is instructed, a program module for instructing a computer to store the first print parameters in a memory, a program module for instructing a computer to obtain the second print parameters of the second document data if printing the second document is instructed after printing the first document is instructed, a program module for instructing a computer to determine whether or not the second print parameters are equal to the first print parameters, and a program module for instructing a computer to display an information that the second print parameters are equal to the first print parameters on a displaying unit, if the second print parameters are equal to the first print parameters.

According to another aspect of the invention, an image formation device, includes a communication interface to receive a first print job and a second print job which are transmitted by a processing device, the processing device transmitting the second print job after transmitting the first print job, the first print job including a first print parameters, the second print job including a second print parameters, a parameter analyzing unit to obtain and analyze the first print parameters, a printer unit to print image data of the first print job based on the first print parameters, a parameter storing unit to store the first print parameters, and a print control unit to instruct to display an information that the second print parameters are equal to the first print parameters on a displaying unit if the second print parameters are equal to the first print parameters, and to print image data of the second print job with the printer unit if the second print parameters are not equal to the first print parameters.

### Description of the First Embodiment

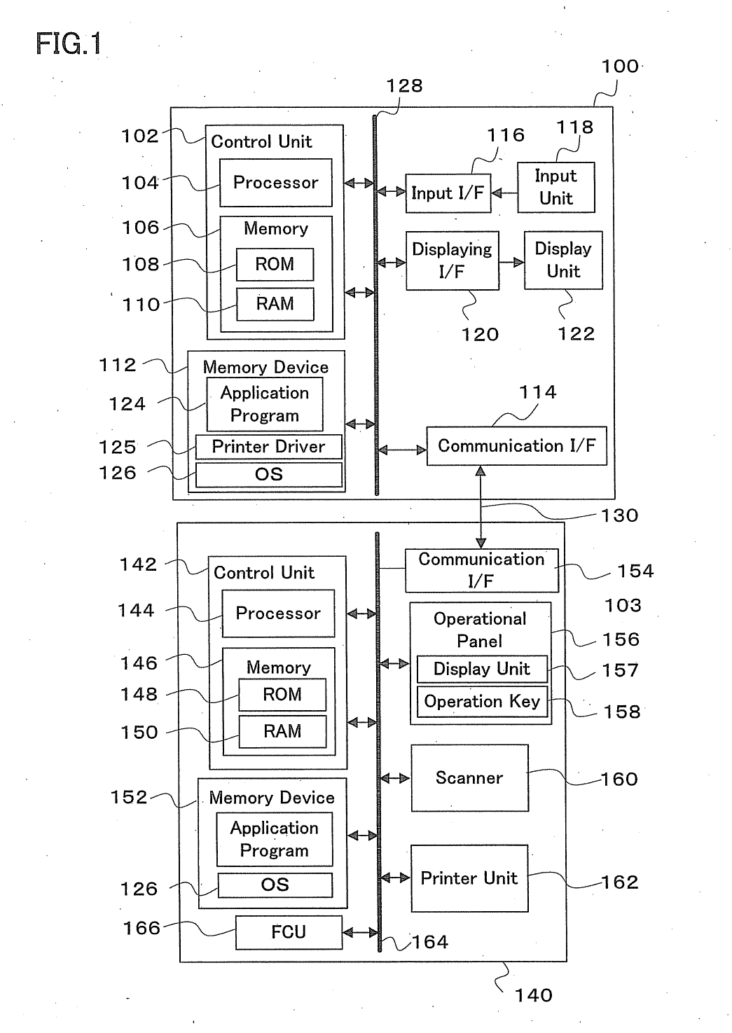

FIG. 1 is a block diagram of a printer controlling system according to the first embodiment. The printer controlling system includes a processing device 100 and an image formation device 140. The processing device 100 and the image formation device 140 are connected to each other through an interactive interface 130.

The processing device 100 includes software and hardware, or combination of the software and the hardware, which are used to communicate with the image formation device 140. The processing device 100 also has an interface such as Web browser or other dedicated application to communicate with web pages and device pages. The processing device 100 includes a control unit 102, a memory device 112, a communication interface (communication I/F) 114, an input interface (input I/F) 116, an input unit 118, a displaying interface (displaying I/F) 120, and a display unit 122. The processing device 100 may be a PC (Personal Computer).

The control unit 102 includes a processor 104 and an internal memory 106. The processor 104 may be a CPU (Central Processing Unit) or a MPU (Micro Processing Unit). The control unit 102 performs document processing for a figure, an image, a letter, and a list. The internal memory 106 may be a semiconductor memory. The internal memory 106 includes a ROM (Read Only Memory) 108 and a RAM (Random Access Memory) 110. The ROM 108 stores a program to control the processor 104. The RAM 110 is used as a temporal work area for the processor 104. These components included in the processing device 100 are connected to each other through a bus 128.

The memory device 112 stores an application program 124, a printer driver 125, and an OS (Operating System) 126. The application program 124 acts as a software of the OS 126. The application program 124 includes a general software and a Web application. The printer driver 125 is a device driver to control the image formation device 140 according to an instruction to execute the print job from the application program 124. The printer driver 125 also acts as a software of the OS 126. The memory device 112 may be any one of a hard disk drive, a magnetic-storage device, an optical-storage device, a semiconductor storage device such as a flash memory, and combination of them.

The communication I/F 114 is an interface to connect the processing device 100 with an external device. The communication I/F 114 may communicate with the image formation device 140 through the interactive interface 130 using a wireless or wired medium such as the Bluetooth (Registered Trade Mark), an infrared ray communication, an optical communication, for example, which are based on any one of IEEE 802.15, IEEE 802.11, IEEE 802.3, and IEEE 1284. The communication I/F 114 may further include a USB connector and a parallel interface. The control unit 102 communicates with the image formation device 140, a USB device (not shown), and other external device (not shown) through the communication I/F 114.

The input I/F 116 is an interface to connect the input unit 118 with the bus 128. The input unit 118 may be a keyboard device and a mouse device as a man-machine interface.

The displaying I/F 120 is an interface to connect the display unit 122 with the bus 128. The displaying I/F 120 receives a data or an instruction to display the data on the display unit 122 from other components connected to the bus 128. The displaying I/F 120 outputs the data to the display unit 122. The display unit 122 may be a display device attached to the PC.

The image formation device 140 includes a control unit 142, a memory device 152, a communication interface (communication I/F) 154, an operation panel 156, a scanner 160 which scans a document, a printer unit 162 which forms the image, and a facsimile control unit (FCU) 166. These components included in the image formation device 140 are connected to each other through a bus 164.

The control unit 142 includes a processor 144 and a second internal memory 146. The processor 144 is a CPU (Central Processing Unit) or a MPU (Micro Processing Unit). The second internal memory 146 may be a semiconductor memory The second internal memory 146 includes a ROM (Read Only Memory) 148 and a RAM (Random Access Memory) 150. The ROM 148 stores a program to control the processor 144. The RAM 150 is used as a temporal work area for the processor 144. The control unit 142 controls the operation panel 156, the scanner 160, the printer unit 162, and the FCU 166 according to a control program stored in the ROM 148 or in the memory device 152. The control unit 142 further performs correction or extension of image data.

The memory device 152 stores an application program 151 and an OS (Operating System) 153. The application program 151 performs functions of the image formation device 140. The functions may be copy, printing, scanner, facsimile, and network filing. The application program 151 may also be an application (Web browser) for a Web client and other application.

The memory device 152 temporarily stores an image data of a document scanned by the scanner 160 or an image data received by the communication I/F 154. The memory device 152 may be a hard disk drive, a magnetic-storage device, an optical-storage device, a semiconductor storage device such as a flash memory, or combination of them. The memory device 152 stores updated software, protected electronic document, text data, account information, and policy information.

The communication I/F 154 is an interface to connect the image formation device 140 with an external device (not shown). The communication I/F 154 may communicate with the external device through the interactive interface 130 using a wireless or wired medium such as the Bluetooth (Registered Trade Mark), an infrared ray communication, an optical communication, for example, which are based on any one of IEEE 802.15, IEEE 802.11, IEEE 802.3, and IEEE 1284. The communication I/F 154 may further include a USB connector and a parallel interface. The control unit 142 communicates with a PC, a USB device, and other external device through the communication I/F 154. In the first embodiment, the control unit 142 communicates with the processing device 100 through the communication I/F 154 and the wireless or wired interactive interface 130.

The operation panel 156 includes a display unit 157 and an operation key 158. The operation key 158 may include a numerical keypad, a reset key, a stop key, and a start key. The display unit 157 displays the print parameters such as a document size, number of print copies, color density, and binding/folding. The user inputs instructions about the print parameters with the display unit 157 or the operation key 158.

The scanner 160 includes a scanning unit, a document table, and an automatic document feeder. The scanning unit is built into the scanner 160. A document is placed on the document table or the automatic document feeder. The scanning unit scans the document to obtain an image data. The automatic document feeder carries the document to a scanning position.

The printer unit 162 forms an image on a sheet. The image is corresponding to the image data scanned by the scanner 160 or the image data sent from the processing device 100.

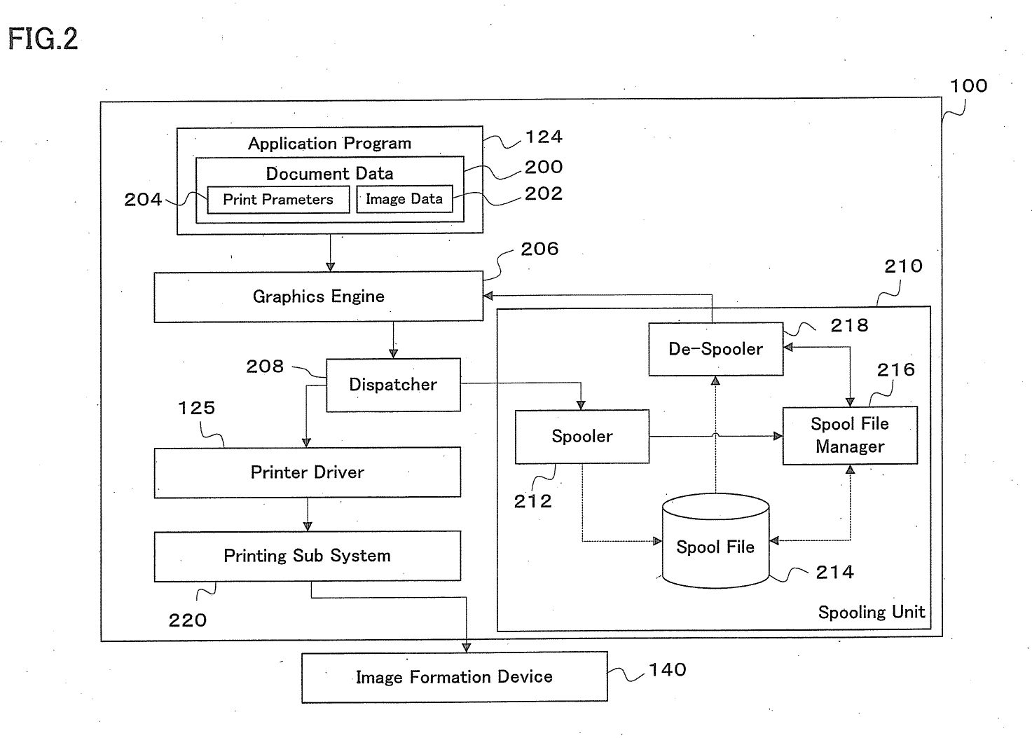

FIG. 2 is a block diagram showing software architecture of the printer controlling system. Next, we will explain printing operation of a document data 200. The document data 200 includes an image data 202 and print parameters 204. The document data 200 may be a data generated by the application program 124, or a data activated or displayed by the application program 124. The processor 104 selects an image formation device, generates print parameters, and converts the image data to an instruction to print it (hereinafter, referred to as “print instruction”) as described below.

In FIG. 2, the processing device 100 includes the application program 124, a graphics engine 206, a dispatcher 208, the printer driver 125, a spooling unit 210, and a printing sub system 220. The application program 124, a graphics engine 206, the printer driver 125, and a printing sub system 220 are program modules stored in the memory device 112. The program modules are loaded into the RAM 110 and executed by the processor 104.

The graphics engine 206 is a drawing module of the OS 126. The graphics engine 206 receives the image data 202 from the application program 124. Then, the graphics engine 206 converts the image data 202 into the print instruction of a print job, and output the print instruction to the dispatcher 208.

The printing sub system 220 schedules the printing jobs, controls connection between the processing device 100 and the image formation device 140, and manages status of the image formation device 140.

When the application program 124 makes the image formation device 140 print the image data, the application program 124 outputs the image data 202 to the graphics engine 206. If the OS 126 receives an indication indicating the printer driver 125 from the input unit 118 and the printer driver 125 is corresponding to the image formation device 140, the graphics engine 206 loads the printer driver 125 from the memory device 112 into the RAM 110. Then, the graphics engine 206 converts the image data 202 received from the application program 124 to the print instruction based on the library, and outputs the converted image data to the printer driver 125.

The printer driver 125 converts the print instruction to a control command which can be understood by the image formation device 140. The control command may be PostScript, PDF (Portable Document Format), XPS (XML Paper Specification), and PDL (Page Description Language). The printing sub system 220 outputs the control command to the image formation device 140 through the communication I/F 114.

Next, we will explain how to modify the image data received from the application program 124 based on the print parameters. The print parameters may be zoom, printing multiple pages into a single sheet of paper (N-up printing, N in 1), duplex printing, and sheet operation after forming the image such as staple, hole punch, folding. The print parameters are set with a setup window supplied by the printer driver 125 through the input unit 118. The image data is modified in a spooling unit 210. The spooling unit 210 includes a spooler 212, a spool file 214, a spool file manager 216, and a de-spooler 218.

The OS 126 receives the indication indicating the printer driver 125 from the input unit 118. The printer driver 125 is corresponding to the image formation device 140 to be used for the print job. The printer driver 125 generates default print parameters for the document data 200. When the print parameters 204 are set up or updated, the printer driver 125 displays the setup window on the display unit 122. The application program 124 sets the print parameters 204 which are inputted through the setup window of the printer driver 125.

The print parameters 204 are temporally stored into the RAM 110 by the application program 124. The print parameters 204 are generated and stored for each of the printer drivers 125 by the application program 124. Data format of the print parameters 204 may be a data structure due to the OS or a text data due to XML (Extensible Markup Language).

For example, in the case of WINDOWS (Registered Trade Mark) which is an OS by Microsoft Corporation, a printer controlling system called as a GDI (Graphics Device Interface) exists. In the GDI, the application program 124 and the printer driver 125 exchanges the print parameters 204 using a memory block called as a DEVMODE structure (which is a data structure using binary). The DEVMODE structure includes a public field and a private field. Specification of the public field is disclosed to the public. On the other hand, specification of the private field is closed to the public but can be accessed by only the printer driver. Some fundamental parameters among the print parameters, for example, a document size, a print direction, and a resolution, are stored in the public field. On the other hand, zoom, printing multiple pages into a single sheet of paper (N-up printing, N in 1), duplex printing are stored in the private field. In other example, in the case of the text data due to XML, the print parameters are stored in a tag called as a print ticket. The application program 124 searches understandable functions in the print ticket, and obtains and modifies each of the print parameters.

If the application program 124 receives an instruction to execute the print job by a user from the input unit 118, the application program 124 instructs the OS 126 to execute the print job. Specifically, the application program 124 outputs the image data 202 to the graphics engine 206. The graphics engine 206 converts the image data 202 to the print instruction, and outputs the print instruction to the dispatcher 208.

If the print instruction is to instruct the image data 202 from the application program 124, the dispatcher 208 loads the spooler 212 from the memory device 112 to the RAM 110, and sends the print instruction to the spooler 212.

The spooler 212 analyzes the print instruction, and converts the print instruction to intermediate code for each page. Then, the spooler 212 stores the intermediate code in the spool file 214 (hereinafter, referred to as “page image file”).

If the printer driver 125 receives the print instruction by a user, the printer driver 125 obtains the print parameters 204 from the application 124. The spooler 212 obtains the print parameters 204 from the printer driver 125, and stores the print parameters 204 in the spool file 214 as a file per job (hereinafter, referred to as “job setting file”). The spool file 214 is provided in the RAM 110 or the memory device 112.

The spooler 212 loads the spool file manager 216 from the memory device 112 to the RAM 110. Then, the spooler 212 indicates condition of the spool file 214 to the spool file manager 216. The spool file manager 216 loads the de-spooler 218 from the memory device 112 to the RAM 110. The spool file manager 216 instructs the de-spooler 218 to print the page image file.

The de-spooler 218 modifies the page image file according to the job setting file to re-generate a modified image data. The de-spooler 218 outputs the modified image data to the graphics engine 206. The graphics engine 206 converts the modified image data to a print instruction, and outputs the print instruction to the dispatcher 208.

If the print instruction come from the de-spooler 218 through the graphics engine 206, the dispatcher 208 sends the print instruction to the printer driver 125.

The printer driver 125 generates control command which is understandable for the image formation device 140 based on the print instruction. Then, the printer driver 125 outputs the control command to the image formation device 140 through the print sub system 220.

The print parameters 204 keeps being stored in the RAM 110 by the application program 124 until the application program 124 terminates. In the conventional technique, after a print job is executed using the printer driver 125, if the application program 124 instructs the printer driver 125 to execute the print job again before the application program 124 terminates, the document data 200 is modified based on the print parameters 204 used in the previous print job (hereinafter, referred to as “first print parameters”) instead of the default print parameters. Therefore, if the first print parameters remains in the image formation device 140 and the user instructs to execute a new print job without setting new print parameters for the new print job (hereinafter, referred to as “second print parameters”), the new print job is executed based on the first print parameters. As a result, an undesired image could be printed.

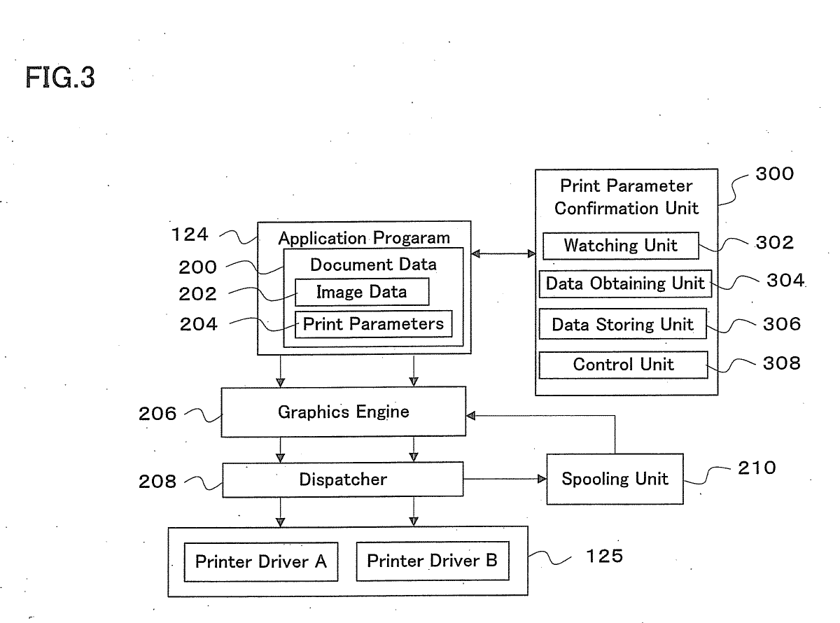

On the other hand, according to the first embodiment, printing the undesired image is avoided by a confirmation function of the print parameters, as described below. FIG. 3 is a block diagram explaining a confirmation function of the print parameters.

A print parameter confirmation unit 300 realizes the confirmation function of the print parameters. The print parameter confirmation unit 300 is a program module stored in the memory device 112. The print parameter confirmation unit 300 acts as a software of the OS 126. The print parameter confirmation unit 300 includes a watching unit 302, a data obtaining unit 304, a data storing unit 306, and a control unit 308. The watching unit 302 watches startup or termination of the application program 124, and arrival of the print instruction from the application program 124. The data obtaining unit 304 obtains the print parameters 204 which is set by the application program 124. The data storing unit 306 stores the print parameters 204. Actually, the print parameter confirmation unit 300 stores the print parameters 204 in the RAM 110 or in the memory device 112. The control unit 308 determines whether or not the print parameters (second print parameters) corresponding to the print instruction from the application program 124 are equal to the print parameters (first print parameters) used for the previous print job. If the control unit 308 determines that the second print parameters are equal to the first print parameters, the control unit 308 indicates it (that is, the second print parameters are equal to the first print parameters) to the user with using the display unit 122. Moreover, the control unit 308 deletes the print parameters stored in the data storing unit 306 when the application program 124 terminates.

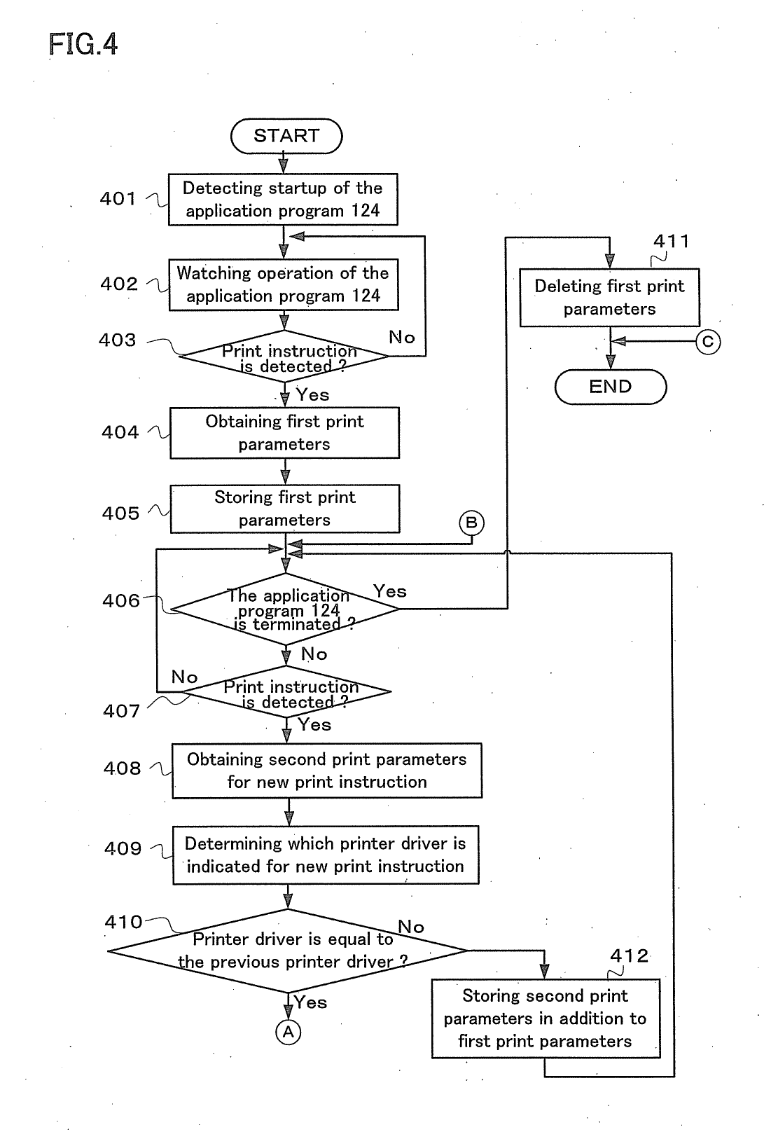

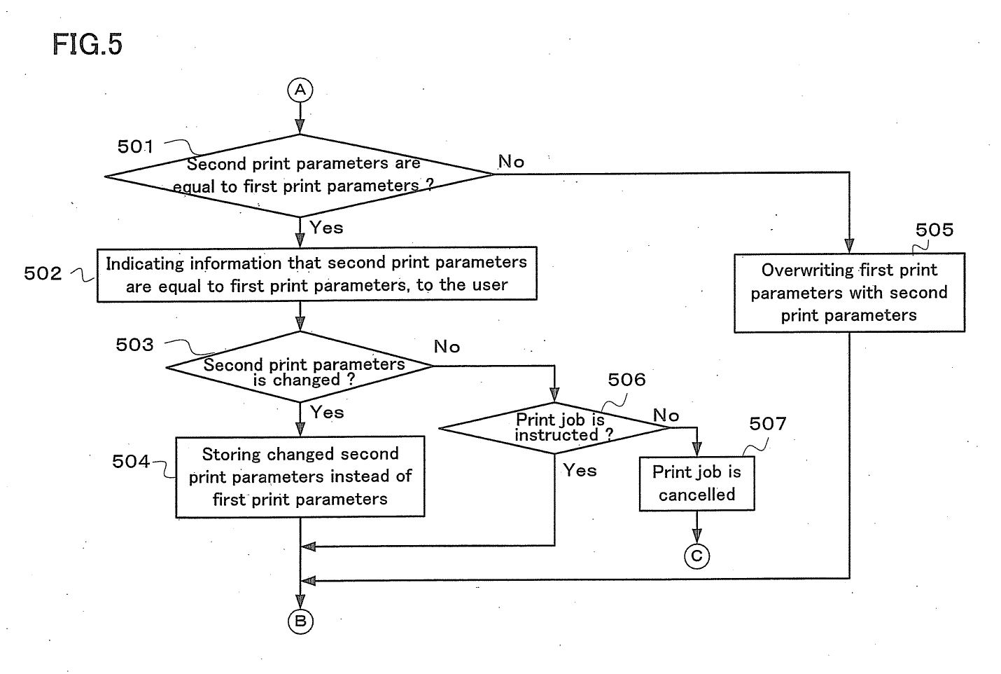

Next, we will explain operation of the print parameter confirmation unit 300. FIGS. 4 and 5 are flow charts explaining operation of the confirmation function of the print parameters.

The watching unit 302 detects the startup of the application program 124 (401). Moreover, the watching unit 302 watches operation of the application program 124 (402). The application program 124 temporally stores the first print parameters 204 which is set through the setup window of the printer driver 125 (hereinafter, referred to as “printer driver “A””) in the RAM 110. The watching unit 302 checks whether or not the print instruction is detected (403). If the watching unit 302 does not detect the print instruction (“No” of 403), the watching unit 302 goes back to 402. The watching unit 302 repeats 402 and 403 until the watching unit 302 detects the print instruction.

If the watching unit 302 detects the print instruction (“Yes” of 403), the data obtaining unit 304 obtains the first print parameters 204 (404). Then, the data storing unit 306 stores the first print parameters 204 (405). The image data 202 of the application program 124 is outputted to the graphics engine 206. Then, the graphics engine 206 modifies the image data 202 based on the first print parameters 204, and the modified image data is printed.

The watching unit 302 watches the termination of the application program 124 (406). If the watching unit 302 does not detect the termination of the application program 124 (“No” of 406), the watching unit 302 keeps watching a new print instruction (407).

If the watching unit 302 detects the new print instruction (“Yes” of 407), the data obtaining unit 304 obtains the second print parameters for the new print instruction (408). The document data of the new print instruction may be same as the document data of the previous print job, or may be a new document data.

The control unit 308 determines which printer driver is indicated for the new print instruction (409). The control unit 308 may determine it by checking the obtained print parameters, or by detecting the printer driver activated by the graphics engine 206.

The control unit 308 determines whether or not the printer driver indicated by the new print instruction is equal to the printer driver “A” corresponding to the first print parameters stored in the data storing unit 306 (410). This means that the control unit 308 determines whether or not the printer driver “A” is indicated more than second times during a time from the startup of the application program 124 to the termination of the application program 124.

If the control unit 308 determines that the printer driver “A” is indicated by the new print indication (“Yes” of 410), the control unit 308 determines whether or not the second print parameters of the new print instruction is equal to the first print parameters stored in the data storing unit 306 (501). This means that the control unit 308 determines whether or not the second print parameters are equal to the first print parameters.

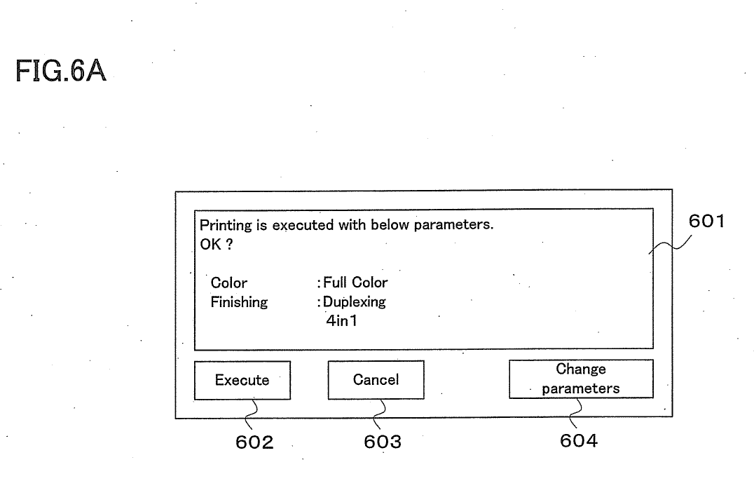

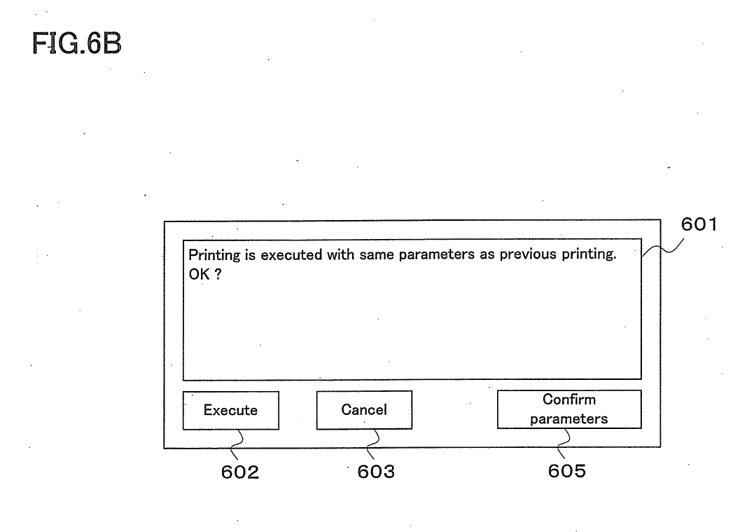

If the control unit 308 determines that the second print parameters are equal to the first print parameters (“Yes” of 501), the control unit 308 indicates it to the user (502), for example, by displaying UI (User Interface) window as a confirmation window on the display unit 122 as shown in FIG. 6A or FIG. 6B. After the previous print job is terminated, if the new print instruction is inputted with remaining the first print parameters, the confirmation window for indicating that the second print parameters are equal to the first print parameters is displayed on the display unit 122 for the user.

In each of FIG. 6A and FIG. 6B, the confirmation window includes a message displaying unit 601, an execution button 602, a cancel button 603, and a print parameter changing button 604 or a confirmation button 605 for the print parameters. The message displaying unit 601 displays a message or the print parameters for the user. The execution button 602 is to instruct execution of the print job based on the print parameters stored in the data storing unit 306. The cancel button 603 is to instruct cancellation of the print job. The changing button 604 for the print parameters is to instruct changing the print parameters. For example, if the changing button 604 is push, a setup window for properties of the printer driver may be invoked. The confirmation button 605 is to instruct displaying a window by which the print parameters set for the application program 124 can be confirmed.

In FIG. 5, the control unit 308 determines whether or not the second print parameters are changed by the user (503). If the second print parameters are changed (“Yes” of 503), the data storing unit 306 stores the changed second print parameters instead of the first print parameters (504). The image data for the document data of the application program 124 is outputted to the graphics engine 206. Then, the graphics engine 206 modifies the image data based on the changed second print parameters, and the modified image data is printed.

If the application program 124 is terminated (“Yes” of 406), the control unit 308 deletes the print parameters stored in the data storing unit 306 (411).

On the other hand, if the printer driver indicated by the new print instruction is not equal to the printer driver stored in the data storing unit 306 (“No” of 410), the data storing unit 306 stores the second print parameters (412) in addition to the first print parameters. Therefore, the application program 124 instructs another printer driver (printer driver “B”) which is different from the printer driver “A” to execute the new print job, the data storing unit 306 stores the second print parameters for the new print instruction using the printer driver “B” in different memory area from area storing the first print parameters for the printer driver “A”. In this case, the data storing unit 306 stores both the first print parameters for the printer driver “A” and the second print parameters for the printer driver “B”. The image data for the document data of the application program 124 is outputted to the graphics engine 206. Then, the graphics engine 206 modifies the image data based on the second print parameters, and the modified image data is printed using the printer driver “B”.

If the second print parameters are not equal to the first print parameters (“No” of 501), the data storing unit 306 overwrites the first print parameters with the second print parameters (505). The image data for the document data of the application program 124 is outputted to the graphics engine 206. Then, the graphics engine 206 modifies the image data based on the second print parameters, and the modified image data is printed using the printer driver “A”.

If the second print parameters is not changed (“No” of 503), the control unit 308 determines whether or not execution of the print job is instructed by the execution button 602 (506). If the execution of the print job is instructed by the execution button 602 (“Yes” of 506), the image data for the document data of the application program 124 is printed using the printer driver “A” without changing the second printing parameters. On the other hand, cancellation of the print job is instructed by the cancel button 603 (“No” of 506), the print job is cancelled (507).

In the printer controlling system according to the first embodiment, printing the undesired image is avoided even if the print parameters for the previous printing remain.

In the first embodiment, the print parameter confirmation unit 300 obtains the print parameters from the application program 124. In other example case, the print parameter confirmation unit 300 may obtain the print parameters from the printer driver 125. The print parameter confirmation unit 300 is provided by software and hardware, or combination of the software and hardware.

The various format can be used for expression of the print parameters.

The dispatcher 208 or the spooling unit 210 may be included in the printer driver 125.

If both of the first and second print parameters are default print parameters, the print parameter confirmation unit 300 may not display the confirmation window. For example, since both of the first and second print parameters are the default print parameters, even if the first print parameters are equal to the second print parameter, the confirmation window is not displayed.

In this case, the data obtaining unit 304 obtains the default print parameters of the printer driver 125 and stores the default print parameters in the data storing unit 306. The data obtaining unit 304 obtains the default print parameters of the printer driver 125 when the print parameter confirmation unit 300 is activated or when the default print parameters of the printer driver 125 are changed, or when a certain time has passed. The default print parameters are obtained from registry in the memory device 112 of the processing device 100. If the data obtaining unit 304 obtains the new default print parameters, the data storing unit 306 overwrites the default print parameters stored before with the new default print parameters.

If the application program 124 instructs to execute the print job, the data obtaining unit 304 obtains the print parameters of the application program 124. The control unit 308 determines whether or not the print parameters are equal to the default print parameters stored in the data storing unit 306. If the print parameters are equal to the default print parameters, the control unit 308 does not display the confirmation window. In this case, the data storing unit 306 may not store duplicate of the default print parameters.

### Description of the Second Embodiment

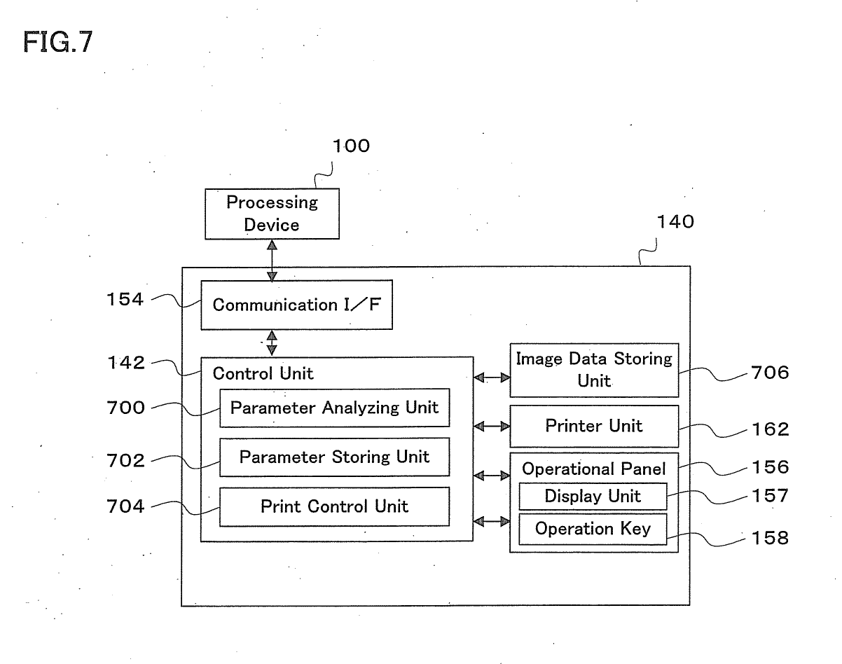

FIG. 7 is a block diagram explaining a confirmation function of the print parameters according to the second embodiment. In the second embodiment, the confirmation function of the print parameters is realized by the control unit 142 of the image formation device 140. The image formation device 140 includes a parameter analyzing unit 700, a parameter storing unit 702, a print control unit 704, and an image data storing unit 706. The parameter analyzing unit 700 analyzes a control command for a print job transmitted by the processing device 100, and generates a raster image (bitmap image) by RIP (Raster Image Processor) operation. Moreover, the parameter analyzing unit 700 obtains the print parameters 204 from the control command. The parameter analyzing unit 700 also obtains identification information which indicates source device of the print job. The parameter storing unit 702 stores the print parameters associated with the identification information. The parameter storing unit 702 may be provided by the RAM 150 or the memory device 152. The print control unit 704 outputs the raster image to the printer unit 162. The print control unit 704 compares the print parameters newly received from the processing device 100 (second print parameters) with the print parameters received from the processing device 100 before (first print parameters). If the print control unit 704 determines that the second print parameters are equal to the first print parameters, the print control unit 704 indicates the information that the second print parameters are equal to the first print parameters to the user. The image data storing unit 706 may be provided by the memory device 152.

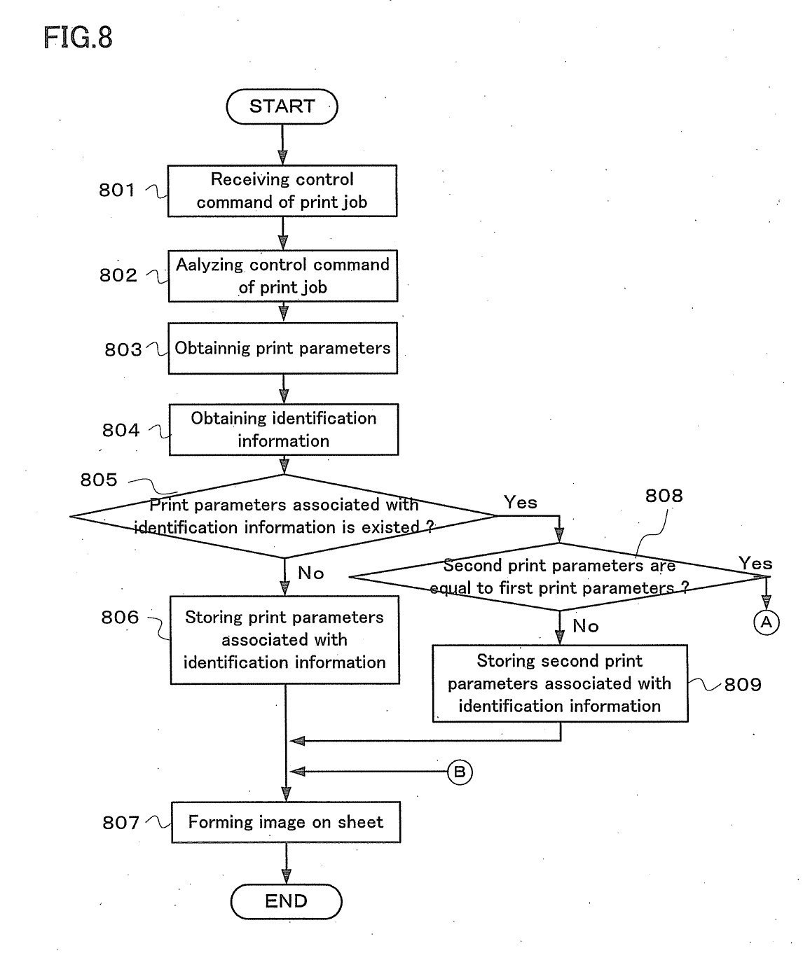

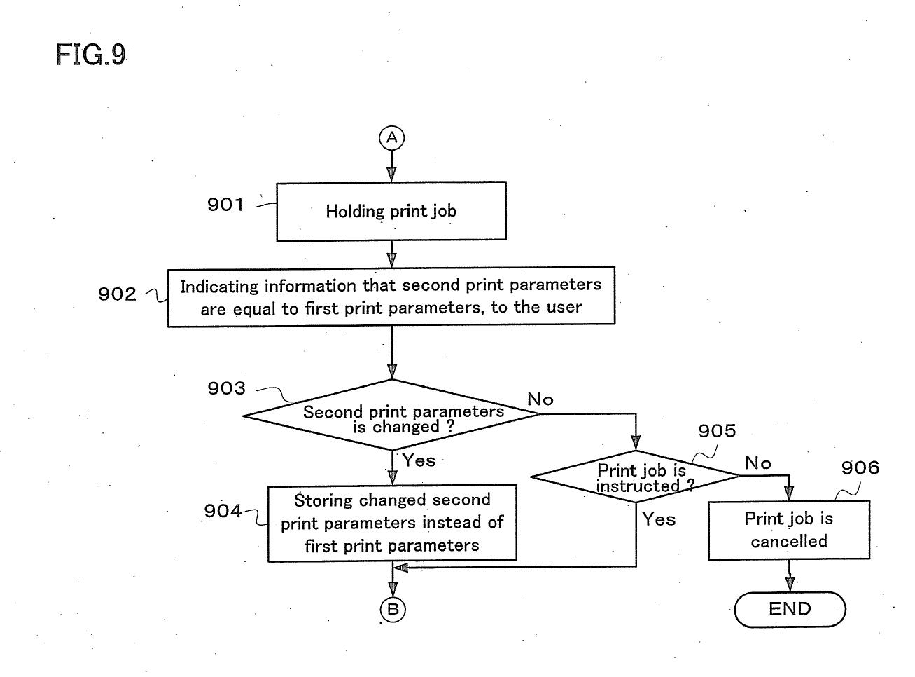

Next, we will explain the operation of the confirmation function of the print parameters. FIG. 8 and FIG. 9 are flow charts explaining operation of the confirmation function of the print parameter in the image formation device 140.

The image formation device 140 receives the control command of the print job from the processing device 100 through the communication I/F 154 (801). The parameter analyzing unit 700 analyzes the control command, and generates the raster image (802). The image data storing unit 706 stores the raster image.

The parameter analyzing unit 700 obtains the print parameters which are set by the printer driver 125 based on result of the analysis of 802 (803). The parameter analyzing unit 700 also obtains the identification information which indicates source device of the print job (804). The identification information may be an IP address or an information to identify a user.

The print control unit 704 determines whether or not the print parameters associated with the identification information exist in the parameter storing unit 702 (805). If the print parameters associated with the identification information do not exist (“No” of 805), the parameter storing unit 702 stores the print parameters associated with the identification information (806). Then, the print control unit 704 outputs the raster image to the printer unit 162. The printer unit 162 forms an image on the sheet based on the raster image (807).

On the other hand, if the print parameters associated with the identification information exist in the parameter storing unit 702 (“Yes” of 805), the print control unit 704 further determines whether or not the print parameters (second print parameters) are equal to the print parameters (first print parameters) stored in the parameter storing unit 702 (808). If the second print parameters are not equal to the first print parameters (“No” of 808), the print control unit 704 instructs the parameter storing unit 702 to discard the first print parameters and store the second print parameters associated with the identification information (809).

On the other hand, if the second print parameters are equal to the first print parameters (“Yes” of 808), the print control unit 704 suspends after finishing RIP operation without outputting the raster image to the printer unit 162 (901). This means that the print control unit 704 inputs the print job into a Hold queue, if the print control unit 704 continuously receives the same print parameters from the same processing device 100 (or a user).

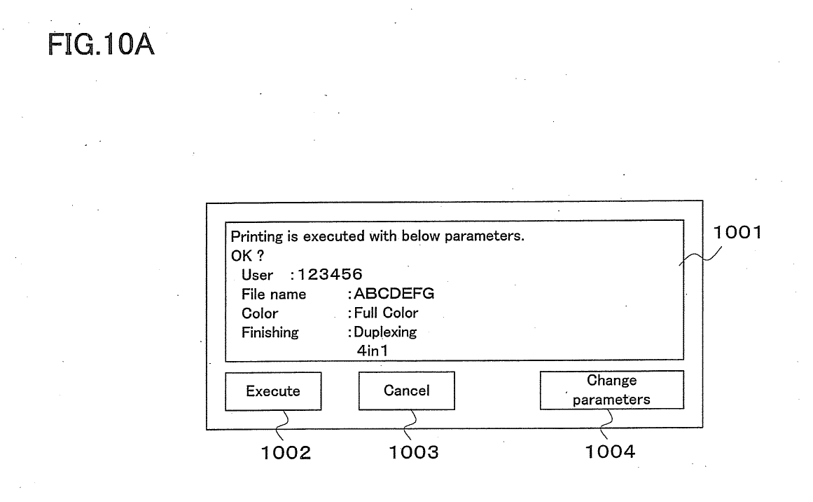

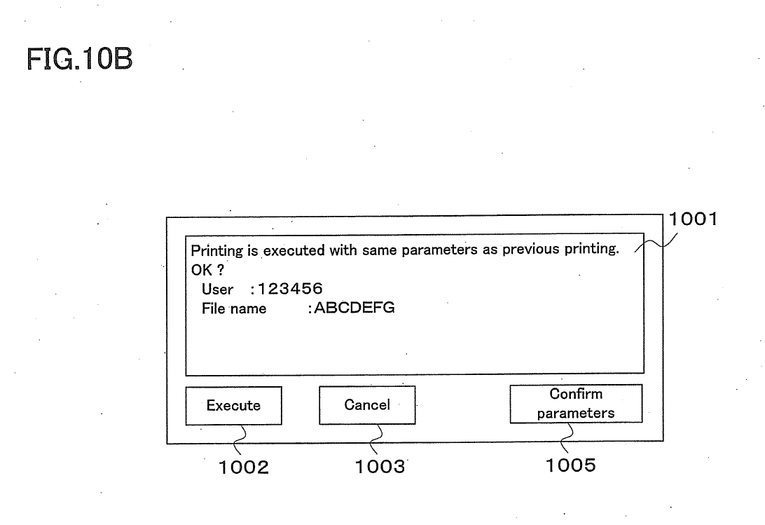

The print control unit 704 indicates to the user that the print control unit 704 receives the duplicate print parameters (902). For example, the print control unit 704 may display an UI (User Interface) window as a confirmation window as shown in FIG. 10A or FIG. 10B on the display unit 157 of the image formation device 140. Or, the print control unit 704 may transmit the confirmation window to the processing device 100. This means that the print control unit 704 displays the confirmation window for the user, if the print control unit 704 continuously receives the same print parameters from the same processing device 100.

In FIGS. 10A and 10B, the confirmation window includes a massage displaying unit 1001, an execution button 1002, a cancel button 1003, and a change button 1004 or a confirmation button 1005 for the print parameters. The massage displaying unit 1001 displays the message or the print parameters for the user. The execution button 1002 is to instruct execution of the printing job waiting in the Hold queue. The cancel button 1003 is to instruct cancellation of the print job. The change button 1004 is to instruct to change the print parameters. For example, if the change button 1004 is push with the operation panel 156 of the image formation device 140, the image formation device 140 displays the setup window of the print parameters on the display unit 157. The confirmation button 1005 is to instruct to display a window by which the print parameters of the print job waiting in the Hold queue can be confirmed. The print job waiting in the Hold queue is formed on the sheet by the printer unit 162, if the operation panel 156 or the processing device 100 instructs to execute forming the image.

In FIG. 9, the print control unit 704 determines whether or not the print parameters are changed (903). If the print parameters are changed (“Yes” of 903), the data storing unit 702 stores the new print parameters instead of the previous print parameters (904). The print control unit 704 modifies or regenerates the raster image stored in the image data storing unit 706 based on the new print parameters. The print control unit 704 outputs the raster image to the printer unit 162. The printer unit 162 forms printing image on the sheet based on the raster image (807).

On the other hand, if the print parameters is not changed (“No” of 903), the print control unit 704 determines whether or not execution of the print job is instructed by the execution button 1002 (905). If the execution of the print job is instructed by the execution button 1002 (“Yes” of 905), the raster image of the print job waiting in the Hold queue is outputted to the printer unit 162 without changing the printing parameters. On the other hand, cancellation of the print job is instructed by the cancel button 1003 (“No” of 905), the print job is cancelled (906).

In the printer controlling system according to the second embodiment, printing the undesired image is avoided even if the print parameters for the previous printing remain.

In the second embodiment, at 902, the confirmation window is displayed on the displaying unit 157 of the image formation device 140 following receiving a new print job. For example, after the new print job is stored in the Hold queue, only if the user instructs the execution of the new print job waiting in the Hold queue with the operation panel 156, the confirmation window may be displayed. In this case, the image formation device 140 may indicate that the new print job is inputted into the Hold queue to the processing device 100.

Moreover, the print control unit 704 determines whether or not the data stored in the parameter storing unit 702 are deleted. The print control unit 704 may delete the data in the parameter storing unit 702, if the image formation device 140 is turned off. Or, the print control unit 704 may delete the data in the parameter storing unit 702, if the image formation device 140 has not received the same print parameters as the print parameters stored in the parameter storing unit 702 for a certain duration.

In the second embodiment, if the processing device 100 receives a print job, the processing device 100 subsequently outputs the print job to the printer unit 162 and forms an image on the sheet. However, in other example, the processing device 100 may hold the print job until the user instructs to execute the print job. (It is called as a private printing.) For example, if the user selects a print job to execute among the print jobs waiting in the Hold queue and the print parameters of the selected print job are equal to the print parameters of the previous job printing, the processing device 100 may indicate that the print parameters are same to the user.

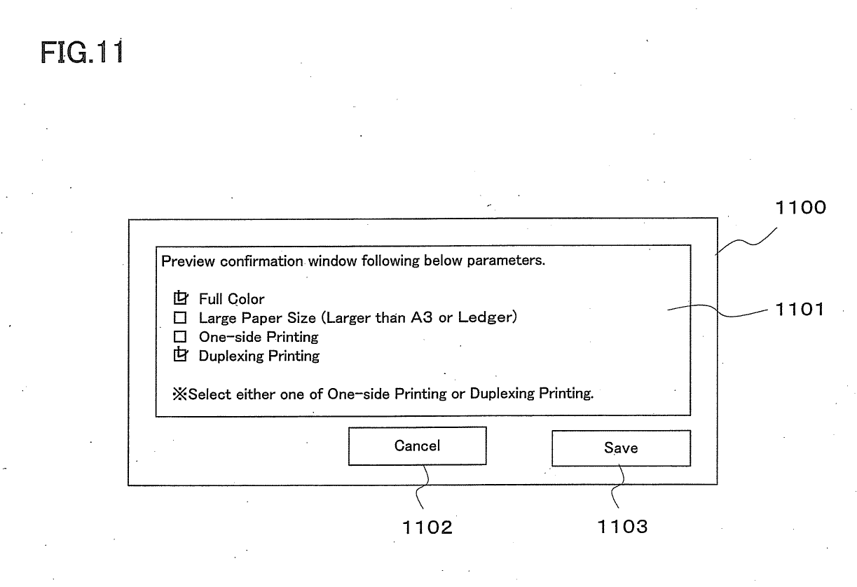

In the first and second embodiments, if the first print parameters of the previous print job remain, the processing device 100 or the image formation device 140 indicates that the same print parameters are holding to the user. However, in other example, the processing device 100 or the image formation device 140 may indicate it to the user, if special print parameters are set among the first print parameters, and the second print parameters are equal to the first print parameters. In this case, the processing device 100 or the image formation device 140 further checks whether or not the special print parameters are set, if the processing device 100 or the image formation device 140 determines that the second print parameters are equal to the first print parameters (“Yes” of 501 in FIG. 5 or “Yes” of 808 in FIG. 8). The user may set the special print parameters with the processing device 100 or the image formation device 140 using a setup window 1100 as shown in FIG. 11. The setup window 1100 includes a setup panel 1101, a cancel button 1102, and a save button 1103. The setup panel 1101 displays the special parameters to be set for displaying the confirmation window. The cancel button 1102 aborts setting the special parameters and makes the setup window disappear. The save button 1103 is to instruct saving the special parameters set from the setup panel 1101. The user may set the special parameters according to the situation, for example, duplex printing for full-color printing which causes increase of the printing cost, or for printing using backing paper. In this case, printing the undesired image is avoided even if the first print parameters for the previous printing remain. Especially, the confirmation window can be displayed according to requirement of the user.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and a entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. A printing control method for a processing device transmitting a first and second document data associated with application program to an image formation device, the first and second document data including first and second print parameters respectively, each of the first and second print parameters being set by a setup window of a printer driver, comprising:
obtaining the first print parameters of the first document data if printing the first document is instructed;
storing the first print parameters in a memory;
obtaining the second print parameters of the second document data if printing the second document is instructed after printing the first document is instructed;
determining whether or not the second print parameters are equal to the first print parameters; and
displaying an information that the second print parameters are equal to the first print parameters on a displaying unit, if the second print parameters are equal to the first print parameters.

2. The method of claim 1, wherein
the second print parameters are obtained if printing the second document is instructed before the application program is terminated.

3. The method of claim 1, further comprising:
overwriting the first print parameters with the second print parameters in the memory, if the second print parameters are not equal to the first print parameters.

4. The method of claim 1, further comprising:
displaying a confirmation window showing the first or second print parameters; and
displaying the setup window on the displaying unit, if the first or second print parameters are changed by the confirmation window.

5. The method of claim 1, wherein
the information that the second print parameters are equal to the first print parameters is not displayed on the displaying unit when the first print parameters are default print parameters, even if the second print parameters are equal to the first print parameters.

6. The method of claim 1, further comprising:
determining whether or not the printer driver of the second document data is equal to the printer driver of the first document data; and
storing the second print parameters in a different area of the memory from the area storing the first print parameters, if the second print parameters are not equal to the first print parameters.

7. A computer readable storage medium storing instructions of a computer program for transmitting a first and second document data associated with application program to an image formation device, the first and second document data including first and second print parameters respectively, each of the first and second print parameters being set by a setup window of a printer driver, the computer program which when executed by a computer results in performance of steps comprising:
a program module for instructing a computer to obtain the first print parameters of the first document data if printing the first document is instructed;
a program module for instructing a computer to store the first print parameters in a memory;
a program module for instructing a computer to obtain the second print parameters of the second document data if printing the second document is instructed after printing the first document is instructed;
a program module for instructing a computer to determine whether or not the second print parameters are equal to the first print parameters; and
a program module for instructing a computer to display an information that the second print parameters are equal to the first print parameters on a displaying unit, if the second print parameters are equal to the first print parameters.

8. The computer readable storage medium of claim 7, wherein
the second print parameters are obtained if printing the second document is instructed before the application program is terminated.

9. The computer readable storage medium of claim 7, further comprising:
a program module for instructing a computer to overwrite the first print parameters with the second print parameters in the memory, if the second print parameters are not equal to the first print parameters.

10. The computer readable storage medium of claim 7, further comprising:
a program module for instructing a computer to display a confirmation window showing the first or second print parameters; and
a program module for instructing a computer to display the setup window on the displaying unit, if the first or second print parameters are changed by the confirmation window.

11. The computer readable storage medium of claim 7, wherein
the information that the second print parameters are equal to the first print parameters is not displayed on the displaying unit when the first print parameters are default print parameters, even if the second print parameters are equal to the first print parameters.

12. The computer readable storage medium of claim 7, further comprising:
a program module for instructing a computer to determine whether or not the printer driver of the second document data is equal to the printer driver of the first document data; and
a program module for instructing a computer to store the second print parameters in a different area of the memory from the area storing the first print parameters, if the second print parameters are not equal to the first print parameters.

13. An image formation device, comprising:
a communication interface to receive a first print job and a second print job which are transmitted by a processing device, the processing device transmitting the second print job after transmitting the first print job, the first print job including a first print parameters, the second print job including a second print parameters;
a parameter analyzing unit to obtain and analyze the first print parameters;
a printer unit to print image data of the first print job based on the first print parameters;
a parameter storing unit to store the first print parameters; and
a print control unit to instruct to display an information that the second print parameters are equal to the first print parameters on a displaying unit if the second print parameters are equal to the first print parameters, and to print image data of the second print job with the printer unit if the second print parameters are not equal to the first print parameters.

14. The image formation device of claim 13, wherein
the print control unit instructs to holding execution of the second print job if the second print parameters are equal to the first print parameters,
and instructs the printer unit to execute the second print job when an instruction to execute the second print job is received after displaying the information that the second print parameters are equal to the first print parameters on the display unit.

15. The image formation device of claim 13, wherein
the parameter analyzing unit obtains not only the first print parameters but also a identification information which indicates the processing device of the first print job;
the parameter storing unit stores the first print parameters associated with the identification information; and
the print control unit determines whether or not the second print parameters are equal to the first print parameters with respect to each identification information.

16. The image formation device of claim 15, wherein
the print control unit instructs to display the identification information and the information that the second print parameters are equal to the first print parameters on a displaying unit if the second print parameters are equal to the first print parameters.

17. The image formation device of claim 13, wherein
the print control unit deletes the first print parameters stored in the parameter storing unit, if the image formation device turns off.

18. The image formation device of claim 15, wherein
the print control unit deletes the first print parameters stored in the parameter storing unit, if a new print job having the identification information which is same as the first print job has not been received for a certain duration.
